(19) United States
(12) Patent Application Publication
(10) Pub. No.: US 2026/0186571 A1
(43) Pub. Date: Jul. 2, 2026

(54) METHOD FOR ONLINE TRAINING OF A BRAIN-COMPUTER INTERFACE, IMPLEMENTING A HIDDEN MARKOV MODEL

(71) Applicant: COMMISSARIAT A L'ÉNERGIE ATOMIQUE ET AUX ENERGIES ALTERNATIVES, Paris (JP)

(72) Inventors: Felix MARTEL, Grenoble Cedex (FR); Tetiana AKSENOVA, Grenoble Cedex (FR)

(73) Assignee: COMMISSARIAT A L'ÉNERGIE ATOMIQUE ET AUX ENERGIES ALTERNATIVES, Paris (JP)

(21) Appl. No.: 19/433,334

(22) Filed: Dec. 26, 2025

(30) Foreign Application Priority Data
Dec. 27, 2024 (FR) FR2415314

(51) Int. Cl. G06F 3/01; G06F 3/0484

(52) U.S. Cl. CPC G06F 3/015; G06F 3/0484

(57) ABSTRACT

The invention relates to a method for training a brain-computer interface, the brain-computer interface being connected to sensors (2₁ . . . 2_{I1}) arranged beforehand around the brain of a user, the interface being configured to control an actuator (6) based on electrophysiological signals detected by each sensor, in various time epochs, by applying multiple predictive models to an observation tensor formed by the signals detected during a time epoch. Each predictive model is associated with a group of states, each group of states comprising states able to be taken by the user. For each group of states, the predictive model makes it possible to estimate a state of the user by implementing a hidden Markov model. A weight is assigned to each time epoch. Each predictive model is implemented taking into account the weight assigned to each epoch, in each group of states.

### TECHNICAL FIELD

The technical field of the invention relates to brain-computer interfaces, or BCIs, intended to control an actuator on the basis of neurophysiological signals.

### PRIOR ART

The field of brain-computer interfaces is undergoing rapid development and appears to provide an attractive solution allowing users with disabilities to control actuators with their minds. This involves detecting and recording electrophysiological signals generated by the cortex. These signals are processed by algorithms allowing a control signal to be formed, with a view to controlling actuators. The control signal is used to control the actuator, the latter being an exoskeleton, a computer or a robot, with a view to providing the user with assistance. The algorithms that are implemented make it possible to translate an instruction given by the user, this instruction being picked up, by electrodes, in the form of signals referred to as electrophysiological signals because they are representative of the electrical activity of neurons. This electrical activity may be measured in the cortex, by way of cortical electrodes arranged in the skull. It may also be measured by electroencephalography electrodes, which are less intrusive because they are arranged on the scalp, but also exhibit poorer performance, in particular in terms of spatial resolution. Another solution is to record electrophysiological signals by magnetoencephalography, this requiring a dedicated apparatus.

The algorithms that are implemented are generally based on a predictive model. The predictive model uses input data, which are obtained by pre-processing the recorded electrophysiological signals, to establish a control signal intended for the one or more actuators. The control signal may reflect an intention expressed by the user whose electrophysiological signals are being recorded. The user's intention manifests itself in the form of the electrophysiological signals, which are recorded and transmitted to the brain-computer interface, as observation data. The electrophysiological signals are processed to obtain the observation data, which form input data of the predictive model, the latter generating a control signal corresponding to the intention expressed by the user. The control signal makes it possible to control the actuator.

The measured signals are processed to form observation data that are generally multidimensional, and which comprise:
a spatial component, representative of the spatial origin of the electrophysiological signal;
a frequency component, representative of the intensity of the electrophysiological signal in various frequency bands; and
a temporal component.

Each observation data is associated with an epoch, that is, a time window of predetermined duration, for example of the order of 1 second, starting after the user first intends to perform the task. In each epoch, an observation tensor collating the observation data is formed. A predictive model is fed with the observation tensor. The predictive model, applied to the observation tensor, makes it possible to estimate a control signal, allowing the actuators to be controlled. The control signal is generally expressed by a control vector.

The predictive model is established during a training phase, during which the user performs predefined tasks, for which the output of the predictive model is known. The objective is then, following each task, to determine components of the recorded electrophysiological signals specific to the task. This may in particular involve determining correlations between components of the electrophysiological signals and the output of the model.

Ways in which predictive models may be established have been widely described. For example, patent U.S. Pat. No. 9,480,583 describes the application of a N-way partial least squares linear regression method allowing a predictive model to be established. Such a method is also known by the acronym NPLS. The application of such a method has also been described in the publication Eliseyev A, Aksenova T (2013) “Recursive N-way Partial Least Squares for Brain Computer Interface” PLOS ONE July 2013, Volume 8 Issue 7 e69962. Such a method is also described in the document Yelisyev A “Brain-Computer Interface with cortical electrical activity recording. Human health and pathology”. Université de Grenoble, 2011.

However, NPLS methods require a large number of training data to be processed, for example several hundred or several thousand training data for a model output corresponding to one specific task. This requires a large amount of information to be stored in memory, something that is incompatible with online training, that is to say training in real time or near real time. Near real time is understood to mean training performed through successive sequences, each sequence lasting a few seconds or a few minutes.

In order to reduce the amount of information to be stored, a training method implementing a REW-NPLS method was developed, REW standing for recursive exponentially weighted. Formation of a predictive model, by REW-NPLS, applied to a BCI, is described in EP3563218. Such an approach is also justified by the fact that neural signals are not immutable, meaning that the predictive model must be regularly updated.

The publication Moly et al. “An adaptative closed-loop ECoG decoder for long-term and stable bimanual control of an exoskeleton by a tetraplegic”, J. neural Eng. 19.026021, 2022, and EP3789852, have described an algorithm for decoding the state of a user, on the basis of observation tensors, adopting the formalism of a chain of hidden Markov states, usually designated by the acronym HMM (hidden Markov model). Decoding is performed using a Markov mixture of experts (MME). Decoding is performed using a forward prediction model, allowing the method to be implemented online. This is sequential decoding, with the states of the user being decoded one after another. This may result in decoding errors, or jerky execution of tasks. The advantage of decoding based on a Markov approach is that of taking into account probabilities of state changes between two successive states of the user. Two successive states of the user are thus not decoded independently of one another. The interdependence between two successive states is considered to be more realistic.

The inventors have discovered an alternative to the method described in EP3789852, allowing the training performance of the predictive model to be improved.

### SUMMARY OF THE INVENTION

A first subject of the invention is a method for training a brain-computer interface, the brain-computer interface being connected to sensors arranged beforehand around the brain of a user, each sensor being configured to detect an electrophysiological signal representative of neural activity of the user, the interface being configured to control an actuator based on detected electrophysiological signals, the training method comprising:
a) selecting a mental task to be performed by the user, chosen from I groups of states, each group of states comprising a list of Kᵢ predetermined tasks, each task in a group of states being able to be performed at the same time as each task in another group of states;
b) the user performing the task selected in step a) and, during performance thereof, acquiring electrophysiological signals from the various sensors, the performance of each task corresponding to a state of the user, and using a processing unit to form an observation tensor based on characteristics of the electrophysiological signals;
c) reiterating steps a) and b) over multiple epochs, each epoch being a time interval, associated with a state, the epochs forming a sequence;
d) forming I training tensors from the electrophysiological signals detected in each epoch, each training tensor being associated with a group of states;
e) forming I control tensors from the selected tasks, each control tensor being associated with a group of states, the value of the control tensor, in an epoch, taking an inactive value when the task selected in said epoch does not belong to the group of states with which the control tensor is associated;
f) for each group of states, forming a predictive model, by way of regression between the training tensor and the control tensor, the predictive model making it possible to estimate a probability of the user being in each state of the group of states;
g) for each group of states, from each predictive model resulting from f), defining a hidden Markov model, each hidden Markov model being configured to estimate a probability of the state of the user in each epoch;
   steps c) to g) being implemented by the processing unit;
   wherein the method further comprises:
defining a weighting criterion for each epoch;
in each group of states, assigning a weight to each epoch, the weight being defined depending on the weighting criterion for said epoch, based on which two different epochs, of the sequence, for which the weighting criterion is different, are assigned two different weights;
   and wherein, in each group of states, the predictive model is formed depending on the weight respectively assigned to each epoch.

According to one possibility, the weight assigned to an epoch depends on the task selected during said epoch and on the group of states.

According to one possibility:
step c) is repeated so as to form multiple successive sequences, each sequence being assigned a chronological rank;
steps d) to g) are implemented for each sequence;
in step f), in each group of states, each predictive model is established from two consecutive sequences, by assigning a forgetting factor to the data resulting from the previous sequence.

According to one possibility, for each group of states, the weighting criterion is a frequency of occurrence of each task, the weight of each epoch being higher the lower the number of occurrences of the task associated with the epoch, following the successive performed sequences.

According to one possibility, in each group of states, after each new sequence, the method comprises an update of a weighted total number of occurrences for each task, the update comprising, for each task:
determining a number of occurrences in the new sequence;
weighting the number of occurrences, during the new sequence, with the weight respectively assigned to the task in the new sequence;
summing the weighted number of occurrences of the task, for the new sequence, to the weighted total number for each task resulting from the lower-ranking sequence, the latter being multiplied by the forgetting factor.

According to one possibility, the weighting criterion is a training performance, the method comprising, for each group of states:
determining a training-performance indicator for each task following each epoch;
determining the weight of each task based on the training-performance indicator for the task.

According to one possibility, the weighting criterion is a quality of the electrophysiological signals detected in each sequence, the method comprising:
determining a criterion concerning the quality of the signals collected in each sequence;
in each group of states, determining the weight of each task based on the criterion concerning the quality of the signals.

According to one possibility, for each group of states, the predictive model is implemented by multivariate regression, this comprising calculation of a cross-covariance tensor expressing the cross-covariance between the training tensor and the control tensor, the cross-covariance tensor of each sequence being established from a product:
of the learning tensor;
of the control tensor;
and of the weights assigned to each epoch.

According to one possibility:
step c) is repeated so as to form multiple successive sequences, each sequence being assigned a chronological rank (u);
steps d) and e) are implemented for each sequence;
in step f), the predictive model is established, in each group of states, from two consecutive sequences, from a sum of the cross-covariance tensor established for the higher-ranking sequence and the cross-covariance tensor established for the lower-ranking sequence multiplied by a forgetting factor.

According to one possibility, in each group of states:
the training tensor and the control tensor are formed from a matrix, one dimension of which is the number of epochs per sequence;
the weights form a diagonal matrix, each dimension of which is the number of epochs per sequence, each term of the diagonal matrix corresponding to the weight assigned to the task respectively performed in said sequence.

According to one possibility, in each group of states, for at least one specific task, the weight is determined such that the number of occurrences of said specific task, weighted by the weight assigned to the specific task, is greater than the number of occurrences of at least one other task, weighted by the weight assigned to said other task.

A second subject of the invention is a brain-computer interface, the brain-computer interface comprising sensors arranged beforehand around the brain of a user, and configured to detect electrophysiological signals representative of neural activity of the user, the interface being configured to control an actuator, by implementing a predictive model, the predictive model being configured to generate an actuator control signal from detected electrophysiological signals, the interface comprising a processing unit configured to acquire the electrophysiological signals in each step b), and to implement steps d) to g) of a method according to the first subject of the invention.

The actuator may be a device external to the user or a device able to be implanted in the user's body.

The invention will be better understood on reading the disclosure of the exemplary embodiments presented, in the remainder of the description, with reference to the figures listed below.

### FIGURES

FIG. 1 schematically shows a brain-computer interface connected to a user, and connected to a processor capable of implementing a method according to the invention.

FIG. 2 shows the main steps of a method for implementing the invention.

FIG. 3 shows examples of parallel decoding performed by implementing the invention.

### DESCRIPTION OF PARTICULAR EMBODIMENTS

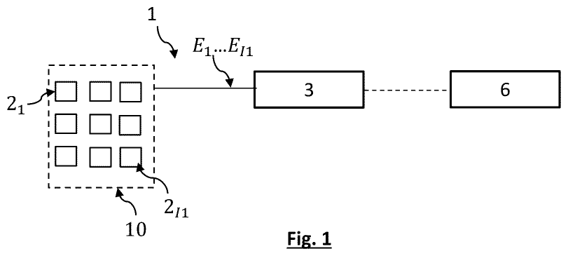

FIG. 1 shows the main elements of a brain-computer interface 1 according to the invention. It is a device comprising sensors 2₁ . . . 2_{I1}, allowing electrophysiological signals representative of neural activity to be acquired. I1 is an integer corresponding to the number of sensors. The sensors 2₁ . . . 2₁ are for example cortical electrodes, the index I1 designating the number of cortical electrodes. The sensors 2₁ . . . 2_{I1} are connected to a processing unit 3, for example a microprocessor, by a wired or wireless link. Each sensor 2₁ . . . 2_{I1} is configured to detect an electrophysiological signal generated by a user 10. On the basis of each detected electrophysiological signal, each sensor 2₁ . . . 2_{I1} transmits an electronic signal E₁ . . . . E_{I1} to the processing unit. The processing unit 3 is configured to implement predictive-model algorithms with a view to detecting characteristics of the electrophysiological signals E₁ . . . . E_{I1} specific to a task performed by the user. The processing unit 3 may for example be a processor connected to a memory implementing instructions for executing decoding algorithms as described in the publications cited in connection with the prior art. Said decoding algorithms make it possible to decode the detected physiological signals, so as to determine characteristics of the electrophysiological signals correlated with mental tasks performed by the user 10.

A mental task, designated task below, is understood to mean an action imagined by a user to whom the brain-computer interface is connected. This is an action corresponding to an intention to perform a specific task. The user is instructed to perform the specific task by a third party or by a dedicated algorithm.

When the brain-computer interface 1 is being operated, as mentioned in relation to the prior art, the user performs mental tasks in succession. The processing unit 3 receives the electrophysiological signals E₁ . . . . E_{I1} transmitted by the sensors 2₁ . . . 2_{I1}, which signals are representative of the electrophysiological signals produced by the user and detected by the sensors. On the basis of the detected electrophysiological signals, when a task is detected, the microprocessor generates a control signal Sc meant for an actuator 6. Thus, the brain-computer interface decodes the electrophysiological signals produced by the user 10 so as to generate, using a predictive model, control signals for controlling an actuator. The higher the quality of the training of the decoding algorithm, the higher the quality of the decoding.

In the prior-art methods, during training, the user is provided with a list T of tasks Tₖ to perform. As described in connection with the prior art, during a training phase, a (human or machine) supervisor may ask the user to perform in succession tasks k chosen from the list of K tasks. The performance of each task corresponds to a state Sₙ of the user at the time n. The objective is to gradually determine the electrophysiological characteristics best correlated with the tasks. These characteristics then make it possible to establish a predictive model that is implemented during decoding, and via which the user 10 is able to control the actuator 6 connected to the processing unit 3.

Each task is to be performed during a time window, called an epoch, n. The number of epochs to be considered during training is very high, and may reach several hundred or several thousand. EP3563218 described segmentation of the training into multiple short sequences. This requires fewer data stored in memory. The decoding model, resulting from one sequence, is then updated in a following sequence. This makes it possible to perform recursive decoding through successive updates of the decoding model. The physiological variability of the user is thus taken into account.

The recorded electrophysiological signals are subjected to pre-processing, in which the signal from each electrode, during each epoch, undergoes frequency analysis. For example, this may involve a wavelet transform, for example a Morlet wavelet transform, or a continuous complex wavelet transform (CCWT). The duration of each epoch n may be 1 second or 2 seconds, with a temporal overlap between two consecutive epochs. More precisely, during each epoch, a frequency analysis is performed at regular intervals, for example every 100 ms. An epoch thus brings together multiple frequency analyses that are shifted in time.

Each epoch n may have an associated observation tensor X̅ₙ:
the first mode of which corresponds to the position of each electrode, of dimension I1;
the second mode of which corresponds to the temporal positions of the wavelets, of dimension I2;
the third mode of which corresponds to the frequency bands resulting from the frequency analysis, of dimension I3.

A training sequence u comprises N epochs n, extending over a time range δt. u is an integer index assigned chronologically to each sequence. Each training sequence has one corresponding training tensor X̅ᵤ, of dimension N×I1×I2×I3: the training tensor X̅ᵤ brings together N observation tensors X̅ₙ. More generally, the training tensor X̅ᵤ is of dimension N×I1 . . . ×Ih× . . . . IH, with 1≤h≤H, h being an index and H being a positive integer. In this example, H=3.

The term tensor encompasses a vector (tensor of order 1), a matrix (tensor of order 2) and tensors of higher order.

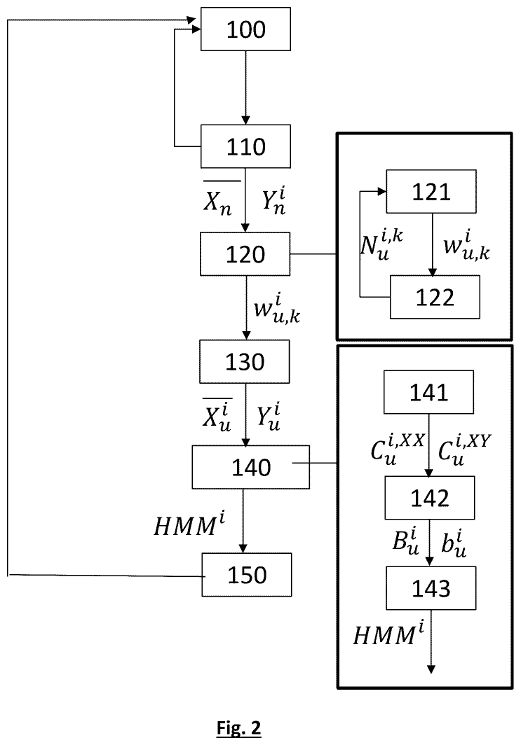

A description will be given, with reference to FIG. 2, of the main steps of training an algorithm for estimating the state of a user in various epochs n. It is known that the predictive model is developed online, that is to say in real time or near real time, with an iterative update of a multivariate linear regression model between the observation tensors and the instructions given to the user. For example, the multivariate linear regression model is established using an N-way partial least squares (NPLS) method, as described in EP3563218.

Steps involving mathematical processing are implemented by the processing unit 3.

Step 100: The user imagines a task k, at a time t, which corresponds to a state of the user. The task associated with the time t may in particular correspond to an action that the user wishes to perform, chosen from multiple possible movements. At the same time, the electrophysiological signals resulting from the various sensors are recorded. More precisely, the electrophysiological signals are recorded during an epoch, n, extending over a duration δt from the time t.

One important aspect of the invention is that it is possible to ask the user to perform multiple actions simultaneously, for example multiple movements, provided that the movements are not mutually exclusive. Two mutually exclusive movements are movements that cannot be performed simultaneously. For example, this may mean performing two non-combinable movements of one and the same limb, for example opening or closing the same hand.

There are thus I groups of states i, i being an integer index with 1≤I. I may for example be equal to 2. Each group of states comprises at least an idle state, along with other active states of the user that are mutually exclusive. The different states of groups are liable to be simultaneous, and therefore cannot be mutually exclusive.

For example, a first group of states, relating to the right hand, containing the states idle, opening and closing, is defined. A second group of states, relating to the left hand, also containing the states idle, opening and closing, is defined.

The invention is based on the simultaneous use of multiple hidden Markov models that differ from one another. Thus, contrary to what has been described in the prior art, during training, in each epoch n, multiple control vectors

$${Y}_{n}^{i} ( k ) ,$$

respectively associated with each group of states, are formed simultaneously. In the example in question, each control vector is a vector comprising 3 terms. More generally, each control signal may be a matrix, or a higher-order tensor. Various control signals associated with two different groups of states may have different dimensions.

In each epoch, a state is determined in each control vector

$${Y}_{n}^{i} .$$

Each term

$${Y}_{n}^{i} ( k )$$

of the control vector corresponds to a state k. The value of

$${Y}_{n}^{i} ( k )$$

is equal to 1 when the user imagines they are performing the movement k and 0 otherwise.

Each epoch n has a corresponding control vector

$${Y}_{n}^{i}$$

of dimension (Kᵢ, 1) Kᵢ is the number of possible states in the group of states i. Each term of the control vector corresponds to one task Tₖ, from the list Tⁱ of Kᵢ predefined tasks in the group of states i. During the N epochs forming the time range u, the various control signals form a matrix

$${Y}_{u}^{i}$$

of dimension (Kᵢ, N).
Step 110: Pre-Processing. In Each Epoch n, the Signals are Subjected to a Time-Frequency Analysis, as Described Above, so as to Form an Observation Tensor X̅ₙ.

Steps 100 and 110 are repeated N times, so as to form a training tensor X̅ᵤ. N may for example be equal to 150. N is the number of epochs n forming the training sequence u. Below, u designates a sequence, that is to say a succession of times of epochs n. For example, the total duration of steps 100 to 110 may be 15 seconds, each epoch lasting a duration δt of 1 second, with an offset of 100 ms between two successive epochs n, n+1, this implying an overlap of 90% between two successive epochs.

### Step 120: Assigning a Weight to Each Class.

It has been indicated that each group of states comprises an idle state (IS). The inventors have found that segmenting the states into multiple groups of states may lead to the idle state being overrepresented during training. For example, when the user is training on states representing movements of the right hand, the control signal corresponding to the left hand is formed solely of idle states. Thus, within each group of states, the idle task is overrepresented, to the detriment of other states. For underrepresented states, the training duration is longer.

To balance the training, in each epoch n, and for each group of states i, a weight

$${w}_{n}^{i}$$

is assigned the value of which varies according to whether it is desired to overweight or underweight the observation in said epoch n, according to the state associated with said epoch. This may for example involve overweighting active states, corresponding to an activity, with respect to an idle state, in one and the same group of states. As an alternative, some states may be underweighted with respect to others. In each group of states, the weight

$${w}_{n}^{i}$$

depends on the task k assigned to the epoch n, among the Kᵢ possible tasks. In each group of states i, the task k assigned to the epoch n corresponds to the non-zero term of the control signal

$${Y}_{n}^{i} .$$

During one and the same sequence u, and in one and the same group of states i, weights

$${w}_{n}^{i}$$

corresponding to one and the same task k, that is to say one and the same task, have the same value.

### Sub-Step 121: Determining the Weights

$${w}_{n}^{i}$$

Following a sequence u, in each group of states i, the weights

$${w}_{n}^{i}$$

are established as follows:

Determining the number of occurrences

$${N}_{u}^{i , m a j}$$

of the majority state after the sequence u:

$${N}_{u}^{i , m a j} = {max}_{k} ( {λ N}_{u - 1}^{i , k} + {n}_{u}^{i , k} ) , \qquad ( 1 )$$

$$where$$

$${N}_{u - 1}^{i , k}$$

is the number of occurrences of each state k following the previous sequence u−1. In the first sequence,

$${N}_{u - 1}^{i , k}$$

is initialized, for example set equal to 0.

$${n}_{u}^{i , k}$$

is the number or occurrences of each state k, during the sequence u, in the group of states i, before weighting.
λ is a forgetting factor, preferably between 0 and 1.

Determining the weight

$${w}_{u}^{i , k}$$

assigned to each state k, vi the group of states i, during the sequence u, by:

$${w}_{u}^{i , k} = \frac{{N}_{u}^{i , m a j} - λ {N}_{u - 1}^{i , k}}{{n}_{u}^{i , k}} \qquad ( 2 )$$

$$and$$

$${w}_{u}^{i , k} = 0 \qquad ( 3 )$$

$$if$$

$${n}_{u}^{i , k} = 0$$

It is preferable for excessive weights not to be assigned, so as not to increase the noise level affecting the determination of the predictive model. This is tantamount to avoiding overweighting certain states k. It is thus possible to set a maximum value

$${w}_{max}^{i} .$$

When (2) leads to a value

$${w}_{u}^{i , k}$$

such that

$${w}_{u}^{i , k} \geq {w}_{max}^{i} ,$$

$$then$$

$${w}_{u}^{i , k} = {w}_{max}^{i} .$$

After the weight

$${w}_{u}^{i , k}$$

assigned to each state k has been defined, the weight

$${w}_{n}^{i}$$

associated with the epoch n is such that

$${w}_{n}^{i} = {w}_{u}^{i , k} ,$$

k corresponding to the state associated with the epoch n in the group of states i.

Sub-step 121 is performed for each group of states i.

### Sub-Step 122: Determining

$${N}_{u}^{i , k}$$

In each group of states i,

$${N}_{u}^{i , k}$$

is determined, this corresponding to the weighted number of occurrences of the class k, by:

$${N}_{u}^{i , k} = {λ N}_{u - 1}^{i , k} + {w}_{n , k}^{i} {n}_{u}^{i , k} \qquad ( 4 )$$

$${N}_{u}^{i , k}$$

is intended to be used in the implementation of expressions (1) and (2) in the following sequence u+1.

In addition to the frequency of occurrence of the tasks, other criteria may be taken into account to assign a weight to each epoch.
training performance: for example, tasks the training performance of which is considered low may be underweighted. Training quality may be assessed via a recall performance indicator, corresponding to a ratio between the number of occurrences of correctly classified tasks and the number of tasks indicated to the user.
the presence of an outlier in the epoch in question, in which case the weight may be set to zero: this involves assigning a weight depending on the quality of the recorded signals, so as to minimize or negate the influence of signals considered to be outliers;
the occurrence of a change in task, times occurring just after a change in task being underweighted with respect to times after the change: this involves taking into account a reaction time of the user, after each change in task, the neurological response of the user being considered to be transient during said time;

More generally, a weighting criterion is defined for each epoch. This may be a frequency-of-occurrence criterion in relation to the task performed in each epoch, or a training-performance criterion in relation to the task selected in each epoch, or a signal-quality criterion in relation to the signals recorded in each epoch, or a time criterion following a change in task. Various weighting criteria may be combined.

### Step 130: Normalizing Training Tensors

Each training sequence u has one corresponding training tensor X̅ᵤ, of dimension N×I1×I2×I3: the training tensor X̅ᵤ brings together N observation tensors X̅ₙ respectively corresponding to N epochs n. Each observation tensor X̅ₙ is formed of terms X̅ₙ(j), j=(j₁ . . . j_{H}) is a multidimensional coordinate in the observation tensor and H is the number of modes of the observation tensor.

Each observation tensor X̅ₙ is normalized, the normalization being specific to each group of states i.

$${N}_{u}^{i , Tot} = λ {N}_{u - 1}^{i , Tot} + {\sum }_{n = 1}^{n} {w}_{n}^{i} \qquad ( 5 )$$

$${N}_{u}^{i , Tot}$$

is a normalization term for the sequence u;

$${N}_{u}^{i , Tot}$$

is the size of the database of training data accumulated since the beginning of the training taking the weights into account.
λ is the forgetting factor described above;

$${w}_{n}^{i}$$

is the weight associated with each epoch n in the sequence u;

$${N}_{u - 1}^{i , Tot}$$

is the normalization term for the previous sequence u−1. In the first sequence (u=1),

$${N}_{0}^{i , Tot} = 0.$$

An average

$${μ}_{u}^{i , j}$$

is then calculated for tau term of coordinate j of the N observation tensors, forming the sequence u. The average takes into account the previous sequences.

$${μ}_{u}^{i , j} = \frac{1}{{N}_{u}^{i , Tot}} ( λ {N}_{u - 1}^{i , Tot} {μ}_{u - 1}^{i , j} + {\sum }_{n = 1}^{N} {w}_{n}^{i} \overline{{X}_{n}} ( j ) ) \qquad ( 6 )$$

X̅ₙ(j) is each term of coordinate j of the observation tensor X̅ₙ.

A sum of squares

$${SS}_{u}^{i , j}$$

is ten calculated:

$${SS}_{u}^{i , j} = λ {SS}_{u - 1}^{i , j} + {\sum }_{n = 1}^{N} {w}_{n}^{i} {\overline{{X}_{n}} ( j )}^{2} \qquad ( 7 )$$

A standard deviation

$${σ}_{u}^{i , j} = \sqrt{\frac{{SS}_{u}^{i , j} - {N}_{u}^{i , Tot} {μ}_{u}^{i , {j}^{2}}}{{N}_{u}^{i , Tot} - 1}}$$

is then calculated (8).

And each term X̅ₙ(j) of the observation tensor is normalized by:

$${\overline{{X}_{n}} ( j )}^{i} ← \frac{{\overline{{X}_{n}} ( j )}^{i} - {μ}_{u}^{i , j}}{{σ}_{u}^{i , j}} , \qquad ( 9 )$$

← meaning “is replaced by”.

This thus gives as many normalized observation tensors

$${\overline{{X}_{n}}}^{i}$$

as there are groups of states i, using the weights

$${w}_{n}^{i}$$

defined in each epoch n, for each group of states. The exponent*expresses the fact that the tensor is normalized.

For each group of states i, the normalized observation tensors

$${\overline{{X}_{n}}}^{i}$$

are brought together to form a normalized training tensor

$${\overline{{X}_{u}}}^{i}$$

corresponding to the sequence u, for each group of states i.

The same approach is taken for each control vector

$${Y}_{n}^{i}$$

respectively defined for each group of states and for each epoch with

An average

$${μ}_{u}^{i , k}$$

is calculated for each term of the N*I control vectors

$${Y}_{n}^{i}$$

for the sequence u, taking into account the previous sequences.

$${μ}_{u}^{i , k} = \frac{1}{{N}_{u}^{i , T o t}} ( λ {N}_{u - 1}^{i , Tot} {μ}_{u - 1}^{i , k} + {\sum }_{n = 1}^{N} {w}_{n}^{i} {Y}_{n}^{i} ( k ) ) \qquad ( 10 )$$

$${Y}_{n}^{i} ( i )$$

is a term of coordinate k of the control vector

$${Y}_{n}^{i} ;$$

A sum of squares

$${SS}_{u}^{i , k}$$

is then calculated:

$${SS}_{u}^{i , k} = ( λ {SS}_{u - 1}^{i , k} + {\sum }_{n = 1}^{N} {w}_{n}^{i} {{Y}_{n}^{i} ( k )}^{2} ) \qquad ( 11 )$$

A standard deviation

$${σ}_{u}^{i , k} = \sqrt{\frac{{SS}_{u}^{i , k} - {N}_{u}^{i , Tot} {μ}_{u}^{i , {k}^{2}}}{{N}_{u}^{i , Tot} - 1}}$$

is then calculated (12)

$${Y}_{n}^{i} ( k ) ← \frac{{Y}_{n}^{i} ( k ) - {μ}_{u}^{i , k}}{{σ}_{u}^{i , k}} \qquad ( 13 )$$

Step 130 consists in normalizing each observation tensor

$${\overline{{X}_{n}}}^{i}$$

and each control tensor

$${Y}_{n}^{i}$$

while taking into account the weight

$${w}_{n}^{i}$$

associated with each epoch n of the sequence u for the group of states i. The aim is to calculate a temporal average and a temporal standard deviation, weighted by the weight assigned to each epoch, of each term of the observation tensors and of the control vector. The temporal average and the temporal standard deviation are calculated for terms of same coordinates, taking into account each epoch n forming the sequence u, as well as the previous epochs, via the forgetting factor λ.

Each normalized observation tensor

$${\overline{{X}_{n}}}^{i}$$

may be expressed in the form of an observation vector

$${X}_{n}^{i} ,$$

of dimension P, with P=I1×I2×I3, following vectorization of the tensor

$${\overline{{X}_{n}}}^{i} ,$$

in which case the training tensor

$${\overline{{X}_{u}}}^{i}$$

is a training matrix

$${X}_{u}^{i}$$

formed from N normalized observation vectors:

$${X}_{u}^{i} = {( {X}_{n = 1}^{i} , ... {X}_{n = N}^{i} )}^{T} .$$

The training matrix

$${{X}_{u}^{i}}^{T}$$

is of dimension (N, P).

A control matrix

$${Y}_{n}^{i}$$

is also formed from each control vector.

$${Y}_{u}^{i} = {( {Y}_{n = 1}^{i} , ... {Y}_{n = N}^{i} )}^{T} .$$

In this example,

$${Y}_{u}^{i}$$

is of dimension (N, Kᵢ).

Thus, for each group of states, and for the sequence u, pairs

$${X}_{u}^{i} , {Y}_{u}^{i}$$

are available.

### Step 140: Parameterizing the Hidden Markov Model.

### Sub-Step 141: Calculating the Covariance Tensors

From the training matrix

$${X}_{u}^{i}$$

and the control matrix

$${Y}_{u}^{i}$$

resulting from the step 130, the covariance and cross-covariance matrices are calculated as follows:

$${C}_{u}^{i , X X} = {X}_{u}^{i , T} diag ( {W}_{u}^{i} ) {X}_{u}^{i} + λ {C}_{u - 1}^{i , X X} \qquad ( 20 )$$

$$and$$

$${C}_{u}^{i , X Y} = {X}_{u}^{i , T} diag ( {W}_{u}^{i} ) {Y}_{u}^{i} + λ {C}_{u - 1}^{i , X Y} \qquad ( 21 )$$

$$diag ( {W}_{u}^{i} )$$

is a diagonal matrix of dimension (N,N). Each term of

$$diag ( {W}_{u}^{i} )$$

is the weight

$${w}_{n}^{i}$$

assigned to the epoch n of the sequence u, for the group of states i, as calculated in step 120.

The covariance and cross-covariance matrices are used to establish the multivariate linear regression, as described in the following sub-step.

Sub-step 142: Determining regression parameters for each state i.

During this step, a multivariate linear regression model Fⁱ is established, using a recursive REW-NPLS algorithm, by projecting the training tensor into a latent space of small dimension, maximizing covariance between the training and control tensors.

As described in the Moly publication, cited in the prior art, and more specifically in paragraph 2.3, it is possible to establish, in each epoch n, parameters of the regression model

$${B}_{u}^{i} and {b}_{u}^{i}$$

such that, at each time n of the sequence u:

$${\hat{Y}}_{n}^{i} = {B}_{u}^{i} {\overline{{X}_{n}}}^{i} + {b}_{u}^{i} \qquad ( 22 )$$

$${B}_{u}^{i}$$

is a matrix of regression coefficients of dimension (Kᵢ, P);

$${b}_{u}^{i}$$

is a bias vector of dimension (Kᵢ, 1).

The determination of the parameters of the regression model

$${B}_{u}^{i} and {b}_{u}^{i}$$

is described for example in step 140 of EP3563218.

$${B}_{u}^{i} and {b}_{u}^{i}$$

are refreshed recursively in each training sequence u, taking into account the parameters

$${B}_{u - 1}^{i} and {b}_{u - 1}^{i}$$

in the previous sequence. In EP3563218, the predictive control model is updated via N-way partial least squares (NPLS) regression, but other types of multivariate regression may be able to be used.

Sub-step 143: Determining a hidden Markov model HMMᵢ for each group of states i.

The regression model Fⁱ defined for each group of states may be used to estimate a most likely state of the user during the epoch n, knowing the previous observations.

The regression model is taken as a basis to determine, for each group of states i, an emission probability vector of dimension (Kᵢ, 1), each term of which, for each state k of the group, is:

$$p ( {S}_{n}^{i} = k \vert {\overline{{X}_{n}}}^{i} ) = softmax ( {B}_{u}^{i} {\overline{{X}_{n}}}^{i} + {b}_{u}^{i} ) \qquad ( 23 )$$

$$p ( {S}_{n}^{i} = k \vert {\overline{{X}_{n}}}^{i} )$$

is a vector of dimension (Kᵢ, 1).

For any vector v, the softmax function is such that:

$$( softmax ( v ) ) ( j ) = \frac{{e}^{v ( j )}}{{\sum }_{l} {e}^{v ( l )}} \qquad ( 24 )$$

The function softmax may be replaced by another monotonic normalization function the arrival space of which is the interval [0; 1].

A transition matrix Tⁱ, of dimension (Kᵢ, Kᵢ), is also calculated in each group of states i, each term of which transition matrix is a probability or transition

$$p ( {S}_{n}^{i} \vert {S}_{n - 1}^{i} )$$

between two successive states in epochs n−1 and n. The transmission probability matrix is determined according to the number of transitions between two successive states during training, taking into account all sequences.

Each term in the diagonal of the transition matrix Tⁱ is a probability of transition from one state to itself.

The probability of transition between two successive states is a vector of dimension (Kᵢ, 1), such that:

$${p}_{n - 1 ; n}^{i} = p ( {S}_{n - 1}^{i} , {\overline{X}}_{1 : n - 1}^{i} ) {T}^{i} \qquad ( 25 )$$

$${p}_{n - 1 ; n}^{i}$$

is a vector of dimension (Kᵢ, 1);

$$p ( {S}_{n - 1}^{i} , {\overline{X}}_{1 : n - 1}^{i} )$$

is determined in the previous iteration, at the time n−1.

In the first iteration,

$$p ( {S}_{0}^{i} , {X}_{1 : 0} )$$

may be chosen to be equiprobable and equal to 1/Kᵢ

$$p ( {X}_{n} \vert {S}_{n}^{i} = k ) = \frac{p ( {S}_{n}^{i} = k \vert {X}_{n} ) p ( {X}_{n} )}{p ( {S}_{n}^{i} = k )} \qquad ( 26 )$$

And, according to (23),

$$p ( {S}_{n}^{i} = k \vert {X}_{n} ) = softmax ( {B}_{u}^{i} {\overline{{X}_{n}}}^{i} + {b}_{u}^{i} ) \qquad ( 27 )$$

p(Xₙ) is a multiplicative coefficient common to all states and

$$p ( {S}_{n}^{i} = k )$$

(a priori probability) is also a constant.

Setting

$$p ( {S}_{n}^{i} = k , {X}_{1 : n} ) = p ( {X}_{n} \vert {S}_{n}^{i} = k ) {\sum }_{l} ( p ( {S}_{n - 1}^{i} = l , {X}_{1 : n - 1} ) p ( {S}_{n}^{i} = k \vert {S}_{n - 1}^{i} = l ) ) \qquad ( 28 )$$

Knowing that:

$$p ( {S}_{n - 1}^{i} = l , {X}_{1 : n - 1} )$$

is determined in the previous iteration, in the epoch n−1;

$$p ( {X}_{n} \vert {S}_{n}^{i} = k )$$

is determined by (26).

This is followed by calculating

$$p ( {S}_{n}^{i} = k \vert {X}_{1 : n} ) = \frac{p ( {S}_{n}^{i} = k , {X}_{1 : n} )}{{\sum }_{l} p ( {S}_{n}^{i} = l , {X}_{1 : n - 1} )} \qquad ( 29 )$$

$$p ( {S}_{n}^{i} \vert {X}_{1 : n} )$$

is a vector of dimension (Kᵢ, 1), defined for each group of states i.

The state of the user during the epoch n is then defined by combining all vectors

$$p ( {S}_{n}^{i} \vert {X}_{1 : n} ) .$$

the state of the user is the state k maximizing

$$p ( {S}_{n}^{i} \vert {X}_{1 : n} )$$

for all groups of states i.

Step 150: Reiterating. Steps 100 to 140 are reiterated for a following training sequence u+1, this allowing each model HMMⁱ to be updated regularly.

### Variant

According to one possibility, it is advantageous, during training, to deliberately aim for a specific imbalance between the occurrences of the states of the user. This may in particular concern a predetermined state, for example the idle state. Insufficient training of the idle state may result in generation, when implementing the models HMMⁱ, of false activations, whereby the user is considered to be in an active state when the desired state is an idle state.

The aim here is to prioritize training of the idle state, knowing that the weighting mentioned above aims not to excessively unbalance training of the idle state with respect to other active states.

For example, a higher proportion of occurrences may be targeted for the idle state than for the other active states of the same group of states. For this purpose, for each state k of each group of states i, a target proportion

$${R}_{k}^{i}$$

is assigned. For example, if there are three states, including 2 active states and the idle state, the target proportions for each active state may be 0.25, and the target proportion for the idle state may be 0.5.

In sub-step 121, the target proportion

$${R}_{k}^{i}$$

is taken into account as follows:

$${N}_{u}^{i , maj} = {max}_{k} ( \frac{λ {N}_{u - 1}^{i , k} + {n}_{u}^{i , k}}{{R}_{k}^{i} .} ) \qquad ( {1}^{′} )$$

$$and$$

$${w}_{u , k}^{i} = \frac{{N}_{u}^{i , maj} {R}_{k}^{i} - λ {N}_{u - 1}^{i , k}}{{n}_{u}^{i , k}} \qquad ( {2}^{′} )$$

The inventors believe that it is preferable, in each group of states, for the idle class to be overrepresented by a factor of 2 to 2.5. This improves decoding performance and stability.

Other weighting variants are described in application FR2415310 filed on 27 Dec. 2024.

### Experimental Trials

ECoG signals were recorded using a wireless WIMAGINE implant as described in Mestais C. et al “WIMAGINE: Wireless 64-channel ECOG recording implant for long term clinical applications”, IEEE Transactions on Neural Systems and Rehabilitation Engineering, Vol. 23, No. 1, January 2015.

An observation tensor was calculated every 100 ms, in a sliding window. The frequency analysis was performed by applying a complex continuous wavelet transform (CCWT) to the latest second of signal, with fifteen wavelets derived from the Morlet mother wavelet, the derived wavelets being centred on fifteen equally spaced frequencies between 10 and 150 Hz.

Each sequence was contained in a buffer storing the data delivered by each sensor for 15 seconds. This corresponds to a set of 150 observation data per buffer. The duration of an epoch was 1 second.

The steps described above were implemented taking into account two groups of states, as described below.

TABLE 1

| Instruction given to the | | |
|---|---|---|
| user | Group 1 (left hand) | Group 2 (right hand) |
| Idle | Idle | Idle |
| Close left hand | Close left hand | Idle |
| Open left hand | Open left hand | Idle |
| Close right hand | Idle | Close left hand |
| Open right hand | Idle | Open right hand |
| Close both hands | Close left hand | Close left hand |
| Open both hands | Open left hand | Open right hand |

The duration of the training was 38 minutes, or 152 sequences.

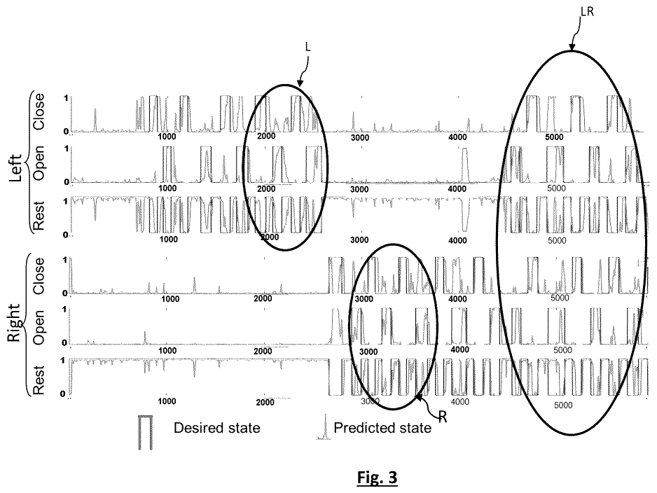

FIG. 3 shows the sequence of states that the user is ordered to perform (instruction), along with the states decoded by implementing the method described above, for the left hand and for the right hand. It is observed that the method makes it possible to decode exclusive sequential movements of the left hand (see for example the states marked “L”) and of the right hand (cf. states marked R), and also simultaneous movements of both hands (states marked “LR”).

Table 2 shows the confusion matrix obtained. The column labels correspond to the real class—the labels on the first row correspond to the predicted class.

TABLE 2

| | | Open | Open | Close | Close | Open | Close |
|---|---|---|---|---|---|---|---|
| | | left | right | left | right | both | both |
| | Idle | hand | hand | hand | hand | hands | hands |
| Idle | 0.79 | 0.07 | 0.04 | 0.06 | 0.02 | 0.01 | 0.01 |
| Open left hand | 0.42 | 0.57 | 0.00 | 0.00 | 0.00 | 0.00 | 0.00 |
| Open right hand | 0.15 | 0.00 | 0.73 | 0.00 | 0.12 | 0.00 | 0.00 |
| Close left hand | 0.46 | 0.14 | 0.00 | 0.40 | 0.00 | 0.00 | 0.00 |
| Close right hand | 0.41 | 0.00 | 0.05 | 0.00 | 0.53 | 0.00 | 0.00 |
| Open both hands | 0.11 | 0.24 | 0.08 | 0.00 | 0.00 | 0.57 | 0.00 |
| Close both hands | 0.27 | 0.15 | 0.00 | 0.28 | 0.12 | 0.00 | 0.18 |

The tasks of closing both hands and closing the left hand are not trained well due to a lack of training data.

For comparison purposes, a model comprising a single HMM was trained taking into account 5 states: idle, open left hand, close left hand, open right hand, close right hand. The same training data were used. The confusion matrix is shown in Table 3.

TABLE 3

| | | Open | Open | Close | Close | Open | Close |
|---|---|---|---|---|---|---|---|
| | | left | right | left | right | both | both |
| | Idle | hand | hand | hand | hand | hands | hands |
| Idle | 0.82 | 0.07 | 0.04 | 0.03 | 0.04 | 0.00 | 0.00 |
| Open left hand | 0.47 | 0.52 | 0.00 | 0.01 | 0.00 | 0.00 | 0.00 |
| Open right hand | 0.19 | 0.00 | 0.66 | 0.00 | 0.15 | 0.00 | 0.00 |
| Close left hand | 0.54 | 0.07 | 0.00 | 0.39 | 0.00 | 0.00 | 0.00 |
| Close right hand | 0.34 | 0.01 | 0.03 | 0.00 | 0.62 | 0.00 | 0.00 |
| Open both hands | 0.05 | 0.43 | 0.49 | 0.02 | 0.00 | 0.00 | 0.00 |
| Close both hands | 0.15 | 0.12 | 0.00 | 0.42 | 0.30 | 0.00 | 0.00 |

A model comprising a single HMM was also trained taking into account 7 states: idle, open left hand, close left hand, open right hand, close right hand, open both hands, close both hands. The same training data were used. The confusion matrix is shown in Table 4.

TABLE 4

| | | Open | Open | Close | Close | Open | Close |
|---|---|---|---|---|---|---|---|
| | | left | right | left | right | both | both |
| | Idle | hand | hand | hand | hand | hands | hands |
| Idle | 0.83 | 0.04 | 0.02 | 0.04 | 0.04 | 0.02 | 0.00 |
| Open left hand | 0.58 | 0.41 | 0.00 | 0.01 | 0.00 | 0.00 | 0.00 |
| Open right hand | 0.19 | 0.00 | 0.59 | 0.00 | 0.21 | 0.00 | 0.00 |
| Close left hand | 0.58 | 0.07 | 0.00 | 0.35 | 0.00 | 0.00 | 0.00 |
| Close right hand | 0.39 | 0.00 | 0.05 | 0.00 | 0.57 | 0.00 | 0.00 |
| Open both hands | 0.09 | 0.28 | 0.18 | 0.00 | 0.00 | 0.45 | 0.00 |
| Close both hands | 0.3 | 0.00 | 0.01 | 0.35 | 0.33 | 0.00 | 0.01 |

An overall performance of each decoding was calculated from the confusion matrices. The overall performance is given by (what is the calculation formula). It was estimated at:
54% by implementing the invention (cf. Table 2);
42.8% by implementing the HMM model based on 5 distinct states;
45.9% by implementing the HMM model based on 7 distinct states.

The invention may be implemented by dedicating a group of states to different joints, for example the wrist, elbow and shoulder joints. This makes it possible to perform various joint movements simultaneously. This thus reduces the production of jerky movements resulting from the implementation of sequential decoding.

The invention may be implemented using a Markov mixture of experts as described in EP4088659.

The invention may be implemented with a view to controlling an actuator 6 external to the user. It may also be implemented with a view to establishing a control signal applied to the spinal cord or, for example, using electrical epidural stimulation (EES) approaches, or to peripheral muscles or nerves, by functional electrical stimulation.

1. A Method for training a brain-computer interface, the brain-computer interface being connected to sensors arranged around the brain of a user, each sensor being configured to detect an electrophysiological signal representative of neural activity of the user, the interface being configured to control an actuator based on detected electrophysiological signals, the training method comprising:
a) selecting a mental task to be performed by the user, chosen from I groups of states, each group of states comprising a list of Kᵢ predetermined tasks, each task in a group of states being executable at the same time as each task in another group of states;
b) executing, by the user the task selected in step a) and, during said execution, acquiring electrophysiological signals from the various sensors, the execution of each task corresponding to a state of the user, and using a processing unit to form an observation tensor based on characteristics of the electrophysiological signals;
c) reiterating steps a) and b) over multiple epochs, each epoch being a time window, associated with a state, the epochs forming a sequence;
d) forming I training tensors from the electrophysiological signals detected in each epoch, each training tensor being associated with one of said group of states;
e) forming I control tensors from the selected tasks, each control tensor being associated with one of said group of states, the value of the control tensor, in an epoch, taking an inactive value when the task selected in said epoch does not belong to the group of states with which the control tensor is associated;
f) for each group of states, forming a predictive model, by way of regression between the training tensor and the control tensor respectively associated to each group of states, the predictive model estimating a probability of the user being in each state of each group of states;
g) for each group of states, from each predictive model resulting from f), defining a hidden Markov model, each hidden Markov model being configured to estimate a probability of the state of the user in each epoch;
wherein steps c) to g) are implemented by the processing unit;
wherein the method further comprises:
defining a weighting criterion for each epoch;
in each group of states, assigning a weight to each epoch, the weight being defined depending on the weighting criterion for said epoch, of the sequence, based on which two different epochs of the sequence, for which the weighting criterion is different, are assigned two different weights;
wherein, in each group of states, the predictive model is formed depending on the weight respectively assigned to each epoch.

2. The Method according to claim 1, wherein the weight assigned to an epoch depends on the task selected during said epoch and on the group of states.

3. The Method according to claim 1, wherein
step c) is repeated so as to form multiple successive sequences, each sequence being assigned a chronological rank;
steps d) to g) are implemented for each sequence;
in step f), in each group of states, each predictive model is established from two consecutive sequences, by assigning a forgetting factor to the data resulting from the lower-ranking sequence.

4. The Method according to claim 3, wherein, for each group of states, the weighting criterion is a frequency of occurrence of each task, the weight of each epoch being higher the lower the number of occurrences of the task associated with the epoch, following the successive performed sequences.

5. The Method according to claim 4, comprising, in each group of states, after each new sequence, updating a weighted total number of occurrences for each task, wherein updating comprises, for each task:
determining a number of occurrences in the new sequence;
weighting the number of occurrences, during the new sequence, with the weight respectively assigned to the task in the new sequence;
summing the weighted number of occurrences of the task, for the new sequence, to the weighted total number for each task resulting from the lower-ranking sequence, the latter being multiplied by the forgetting factor.

6. The Method according to claim 1, wherein the weighting criterion is a training-performance criterion, the method further comprising, for each group of states:
determining a training-performance indicator for each task following each epoch;
determining the weight of each task based on the training-performance indicator for the task.

7. The Method according to claim 1, wherein the weighting criterion is a quality of the electrophysiological signals detected in each sequence, the method comprising:
determining a criterion concerning the quality of the signals collected in each sequence;
in each group of states, determining the weight of each task based on the criterion concerning the quality of the signals.

8. The Method according to claim 1, wherein, for each group of states, the predictive model is implemented by multivariate regression, comprising calculating a cross-covariance tensor expressing the cross-covariance between the training tensor and the control tensor, the cross-covariance tensor of each sequence being established from a product:
of the learning tensor respectively associated to each group of states;
of the control tensor respectively associated to each group of states;
and of the weights assigned to each epoch.

9. The Method according to claim 8, wherein:
step c) is repeated so as to form multiple successive sequences, each sequence being assigned a chronological rank;
steps d) and e) are implemented for each sequence;
in step f), the predictive model is established, for each group of states, from two consecutive sequences comprising a high-rank sequence and a low-rank sequence, with a sum of:
the cross-covariance tensor established for the high-rank sequence; and
the cross-covariance tensor established for the lor-rank sequence multiplied by a forgetting factor.

10. The Method according to claim 8, wherein, in each group of states:
the training tensor and the control tensor are formed from a matrix, one dimension of which is the number of epochs per sequence;
the weights form a diagonal matrix, each dimension of which is the number of epochs per sequence, each term of the diagonal matrix corresponding to the weight assigned to the task respectively performed in said sequence.

11. The Method according to claim 1, wherein, in each group of states, for at least one specific task, the weight is determined such that the number of occurrences of said specific task, weighted by the weight assigned to the specific task, is greater than the number of occurrences of at least one other task, weighted by the weight assigned to said other task.

12. A Brain-computer interface, comprising sensors configured to be arranged around the brain of a user, and configured to detect electrophysiological signals representative of neural activity of the user, the interface being configured to control an actuator, by implementing a predictive control model, the predictive model being configured to generate an actuator control signal from detected electrophysiological signals, the brain-computer interface comprising a processing unit configured to acquire the electrophysiological signals in each step b), and to implement steps d) to g) of the Method according to claim 1.

13. The Brain-computer interface according to claim 12, wherein the actuator is a device external to the user or a device able to be implanted in the user's body.
